(19) United States
(12) Patent Application Publication
(10) Pub. No.: US 2005/0249235 A1
(43) Pub. Date: Nov. 10, 2005

(54) METHOD OF ACCESSING A MAC ADDRESS FOR A NIC DEVICE

(76) Inventor: Lian-Chun Lee, Kao-Hsiung Hsien (TW)

Correspondence Address: NORTH AMERICA INTELLECTUAL PROPERTY CORPORATION, P.O. BOX 506, MERRIFIELD, VA, 22116, US

(21) Appl. No.: 10/709,463

(22) Filed: May 7, 2004

(51) Int. Cl. H04L 12/66

(52) U.S. Cl. 370/463

(57) ABSTRACT

A method of accessing a MAC address or a 1394 GUID serial number for a NIC removes the serial ROM of the processing system and utilizes a BIOS or a CMOS register to store the MAC address or the 1394 GUID serial number. The method includes storing the MAC address or the 1394 GUID serial number into a BIOS and loading the MAC address or the 1394 GUID serial number from the BIOS into an operational register of the NIC.

### BACKGROUND OF INVENTION

1. Field of the Invention

The present invention relates to an accessing method, and more particularly, to a method of accessing a MAC address or a 1394 GUID serial number for a NIC device.

2. Description of the Prior Art

With the rapid development of information technology, processing systems play important roles in modern society. To implement more functions, processing systems have to be equipped with more complicated building blocks or peripheral devices. Accordingly, more circuits should be integrated on a mainboard of a computer, which increases cost and complexity of the mainboard.

Please refer to FIG. 1. FIG. 1 illustrates a schematic function diagram of a processing system 10 according to the prior art. The processing system 10 includes a central processing unit (CPU) 12, a network interface controller (NIC) 14, a serial ROM 16, a basic input/output system (BIOS) 18, and a bus 22. The CPU 12 maintains operations of the processing system 10. The BIOS, which is usually a flash memory, is used to store programs for starting the processing system 10 (such as a variety of check processes and operation arguments). The NIC device 14 can be an Ethernet card or an IEEE 1394 card for processing network communications. The ROM 16 connected to the NIC device 14 is used to store the media access control (MAC) address or 1394 globally unique identifier (GUID). The bus 22 can exchange data with the central processing unit 12 to achieve the functionality of the processing system 10.

Each NIC has its own MAC address, which is like an ID number, representing the unique physical address of the NIC device. The physical address has six bytes. The first three bytes represent the number of the manufacturer and the last three bytes represent the number of the Ethernet card. Theoretically speaking, the MAC address of each NIC device is unique because it stands for the unique ID of each NIC device. Similar to the MAC address, the 1394 GUID serial number also represents the ID of an IEEE 1394 controller for the purpose of communication in a network. In the prior art, a MAC address or a 1394 GUID serial number is stored in a serial ROM (for example, the ROM 16 in FIG. 1). When a PC starts to connect to a network, the driver of the NIC reads the MAC address or the 1394 GUID serial number from the serial ROM. Therefore, in a local area network, in an Ethernet, or in a 1394 network system, each PC equipped with a NIC can share information.

However, in modern processing systems, there is a tendency to integrate all circuits into a mainboard. With the increasing functions of the processing system, the circuitry of a mainboard becomes more complicated. If each NIC is equipped with a serial ROM to store a MAC address, both layout area and cost of a mainboard limit the economic value of production. Therefore, the structure to access a MAC address for a NIC can be improved.

### SUMMARY OF INVENTION

It is therefore a primary objective of the claimed invention to provide a method of accessing a MAC address or a 1394 GUID serial number to solve the above-mentioned problem.

According to the claimed invention, a method of accessing a MAC address or a 1394 GUID serial number for a NIC comprises: storing the MAC address or the 1394 GUID serial number into a BIOS and loading the MAC address or the 1394 GUID serial number from the BIOS into an operational register of the NIC device.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a block diagram of a processing system according to the prior art.

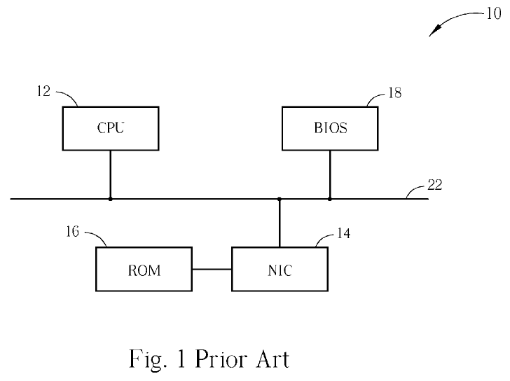

FIG. 2 illustrates a portion of a processing system according to the present invention.

FIG. 3 illustrates a portion of a processing system of another embodiment according to the present invention.

FIG. 4 illustrates a method of accessing a MAC address or a 1394 GUID serial number for a NIC device according to the present invention.

FIG. 5 illustrates another embodiment of accessing a MAC address or a 1394 GUID serial number for a NIC device according to the present invention.

FIG. 6 illustrates another embodiment of accessing a MAC address or a 1394 GUID serial number for a NIC device according to the present invention.

### DETAILED DESCRIPTION

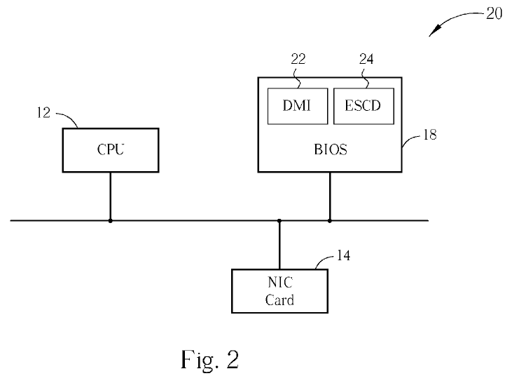

Please refer to FIG. 2. FIG. 2 illustrates a portion of a processing system 20 according to the present invention. The processing system 20 comprises a CPU 12, a BIOS 18 and a NIC device 14. The BIOS 18 comprises a desktop management interface (DMI) 22 and extended system configuration data (ESCD) 24. In the prior art, a serial ROM is required for a NIC to store a MAC address. However, since the BIOS 18 is a flash memory, the MAC address can be stored in the BIOS 18. Notice that the serial ROM for the NIC device 14 is removed in FIG. 2 according to the present invention. The function of the serial ROM is replaced by the BIOS 18. Therefore, the processing system 20 does not need the serial ROM and the layout area as well as cost of the mainboard can be reduced.

There are two sections, the DMI 22 and the ESCD 24, in the BIOS 18. The DMI 22 is a hardware system that assists in searching for information of the computer. The DMI 22, similar to the interface between a management tool and a system device, builds a standard and manageable system for a computer manufacturer or a computer user to understand the processing system easily. A user can obtain a serial number, the computer manufacturer, information about serial ports and other information about system devices through the DMI. The ESCD 24 is a nonvolatile database. It stores both information of both plug and play (PnP) and non-PnP devices. In the preferred embodiment of the present invention, a MAC address or a 1394 GUID is stored in the DMI 22 or the ESCD 24 sections of the BIOS 18 in order to prevent the MAC address or the 1394 GUID from being destroyed neglectfully.

When the processing system 20 is manufactured, it needs to execute updating programs for DMI or ESCD so that each NIC device or each 1394 controller is given a unique and legal MAC address or GUID serial number. Besides, a BIOS can also provide users an input interface to set or change the MAC address and the GUID serial number. The changed result is stored in the BIOS. If the MAC address and the GUID serial number are confirmed to be correct, they will be loaded into the NIC device 14 after the processing system is started. Therefore, the NIC device 14 is able to play the role of connecting to the Internet in a network.

A processing system can be a well-known computer system, a mobile phone or a personal digital assistant (PDA) that can connect to a wireless LAN, a Bluetooth device, a networking device, etc.

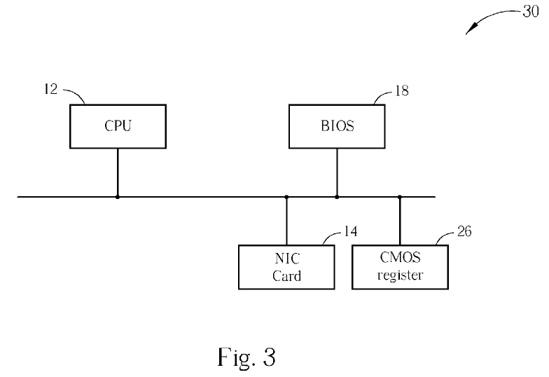

Please refer to FIG. 3. FIG. 3 illustrates a portion of a processing system 20 of another embodiment according to the present invention. The processing system 20 comprises a CPU 12, a BIOS 18, a NIC device 14 and a CMOS register 26. The processing system 30 in FIG. 3 is similar to the processing system 20 in FIG. 2. However, the processing system 30 also has a CMOS register 26, which is an ordinary memory included in a conventional mainboard. In this embodiment, a MAC address or a GUID serial number is stored in the CMOS register 26, instead of in the BIOS 18. The MAC address and the GUID serial number are loaded into the NIC device 14 after the processing system 30 is started. Therefore, the processing system 30 can connect to the Internet or a network through the NIC device 14.

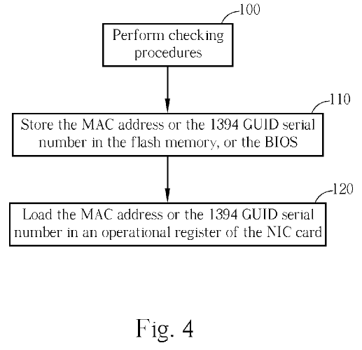

Please refer to FIG. 4. FIG. 4 illustrates a method of accessing a MAC address or a 1394 GUID serial number for a NIC device. The present invention method is applied to a processing system equipped with a NIC device. In the processing system, a serial ROM connected to the NIC device for storing a MAC address or a 1394 GUID serial number is removed. Therefore, a BIOS of the processing system is used to store the MAC address or the 1394 GUID serial number. Here, the processing system means a computer, a mobile phone or a PDA that can connect to a wireless LAN, a Bluetooth device, a networking device, etc. In step 100, checking procedures are performed. The checking procedures comprise checking whether the NIC of the processing system is enabled and checking whether the MAC address or the 1394 GUID serial number is valid. The checking procedures make sure that the following steps of accessing a flash memory or the NIC do not get wrong addresses. In step 110, the MAC address or the 1394 GUID serial number is stored in the flash memory or the BIOS. The function of a conventional serial ROM for the NIC device is totally replaced by the BIOS. Thus, the conventional serial ROM is not needed here anymore, but the NIC can still easily fetch the MAC address or the 1394 GUID serial number from the BIOS. In step 120, the MAC address or the 1394 GUID serial number is loaded into an operational register of the NIC device. Then, the processing system is able to connect to the Internet through the NIC device with a unique and definite address.

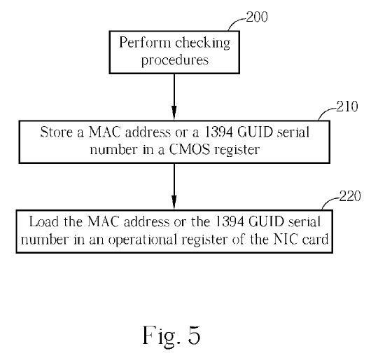

A BIOS is a nonvolatile memory in a processing system for storing data. In addition to this flash memory, other kinds of memory originally built into a processing system can also be used for storing a MAC address or a 1394 GUID serial number. Therefore, a NIC device can easily fetch its ID address from another memory without a conventional serial ROM. Please refer to FIG. 5. FIG. 5 illustrates another embodiment of accessing a MAC address or a 1394 GUID serial number for a NIC device according to the present invention. In step 200, similar to step 100 in FIG. 4, checking procedures are performed. In step 210, a MAC address or a 1394 GUID serial number is stored in a CMOS register. Since the CMOS register is a memory originally built in a processing system, it is used to store the address of the NIC device in the embodiment. In the final step, step 220, the MAC address or the 1394 GUID serial number is loaded into an operational register of the NIC device.

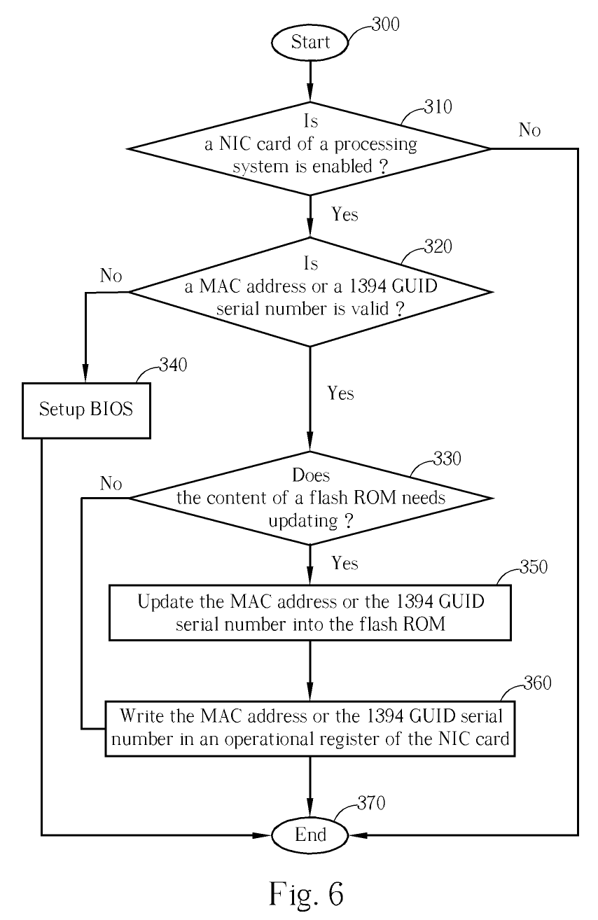

Please refer to FIG. 6. FIG. 6 illustrates another embodiment of accessing a MAC address or a 1394 GUID serial number for a NIC device according to the present invention. In step 310, whether a NIC device of a processing system is enabled is checked. If the NIC device is detected, step 320 is executed or the whole procedure is finished. In step 320, whether a MAC address or a 1394 GUID serial number is valid is checked. If there is no problem, then step 330 is executed. If the MAC address or the 1394 GUID serial number is illegal, then the BIOS is setup in step 340. In step 330, whether the content of a flash ROM needs updating is determined. Execution of step 350 is maintained if the result of step 330 is “Yes”. Step 360 is executed if the result of the step 330 is “No”. In step 350, the MAC address or the 1394 GUID serial number is updated into the flash ROM. In step 360, the MAC address or the 1394 GUID serial number is written into an operational register of the NIC device. Step 370 is the end of the entire procedure. Of course, the flash ROM mentioned in FIG. 6 can be replaced by any other memory originally built into the processing system. For example, a CMOS register is for storing a MAC address or a 1394 GUID serial number in the procedure of FIG. 6.

Please note that in the preferred embodiment in FIG. 6, a MAC address or a 1394 GUID serial number will be stored in a DMI region or an ESCD region of the BIOS. In addition, the MAC address or the 1394 GUID serial number can also be stored in another kind of memory originally built into the processing system, such as CMOS register.

In the prior art, a MAC address or a 1394 GUID serial number is stored in a serial ROM connected to a NIC device. When a PC starts to connect to a network, the driver of the NIC reads the MAC address or the 1394 GUID serial number from the serial ROM. Therefore, each PC equipped with a NIC can share information together in the Internet. However, as more functions are integrated in circuitry of a modern mainboard, a processing system becomes more complicated. The serial ROM that stores a MAC address increases both layout area of a mainboard and production cost. In contrast to the prior art, the method of the present invention removes the serial ROM of the processing system and utilizes a BIOS, a CMOS register or other memory originally existing in the processing system to store a MAC address or a 1394 GUID serial number. The MAC address or the 1394 GUID serial number is loaded into the NIC device so that the processing system can connect to the Internet through the NIC device. Therefore, the present invention uses less hardware and circuit elements to implement access of a MAC address or a 1394 GUID serial number without losing any conventional functionality.

Those skilled in the art will readily observe that numerous modifications and alterations of the device may be made while retaining the teachings of the invention. Accordingly, the above disclosure should be construed as limited only by the metes and bounds of the appended claims.

1. A method of accessing a media access control (MAC) address or a 1394 globally unique identifier (GUID) serial number for a network interface controller (NIC) comprising:
storing the MAC address or the 1394 GUID serial number into a basic input/output system (BIOS); and
loading the MAC address or the 1394 GUID serial number from the BIOS into an operational register of the NIC.

2. The method of accessing a MAC address or a 1394 GUID serial number in claim 1 further comprising checking if the NIC is enabled.

3. The method of accessing a MAC address or a 1394 GUID serial number in claim 1 further comprising checking if the MAC address is valid.

4. The method of accessing a MAC address or a 1394 GUID serial number in claim 1 wherein storing the MAC address or the 1394 GUID serial number into a BIOS comprises storing the MAC address or the 1394 GUID serial number into a desktop management interface (DMI) region or an extended system configuration data (ESCD) region of the BIOS.

5. A method of accessing a MAC address or a 1394 GUID serial number for a NIC device comprising:
storing the MAC address or the 1394 GUID serial number into a CMOS register; and
loading the MAC address or the 1394 GUID serial number from the CMOS register into an operational register of the NIC device.

6. The method of accessing a MAC address or a 1394 GUID serial number in claim 5 further comprising checking if the NIC device is enabled.

7. The method of accessing a MAC address or a 1394 GUID serial number in claim 5 further comprising checking if the MAC address is valid.
